(19) United States
(12) Patent Application Publication
(10) Pub. No.: US 2011/0246962 A1
(43) Pub. Date: Oct. 6, 2011

(54) STATE MACHINE EXPRESSIONS IN DATABASE OPERATORS

(75) Inventors: Henricus Johannes Maria Meijer, Mercer Island, WA (US); Dragos A. Manolescu, Kirkland, WA (US); Jeffrey van Gogh, Redmond, WA (US); John Wesley Dyer, Monroe, WA (US); Brian C. Beckman, Newcastle, WA (US)

(73) Assignee: Microsoft Corporation, Redmond, WA (US)

(21) Appl. No.: 12/753,908

(22) Filed: Apr. 5, 2010

(51) Int. Cl. G06F 9/45; G06F 9/44

(52) U.S. Cl. 717/106; 717/140

(57) ABSTRACT

A state machine may be represented using event-driven objects in a database query language. A bind operator from a database query language may be used as a state transition function, where the transition function has side effects defining the state. The objects may be manipulated with event driven expressions and operators and perform what would otherwise be complex operations with simple state machines.

### BACKGROUND

State machines are one mechanism to design real-time systems and hardware. State machine theory and optimization has been developed and widely deployed in hardware, although not as much in software.

### SUMMARY

A state machine may be represented using event-driven objects in a database query language. A bind operator from a database query language may be used as a state transition function, where the transition function has side effects defining the state. The objects may be manipulated with event driven expressions and operators and perform what would otherwise be complex operations with simple state machines.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a device that may execute a state machine using a database query language.

FIG. 2 is a flowchart illustration of an embodiment showing a method for using database query language for expressing state machines.

FIG. 3 is a diagram illustration of an embodiment showing a finite state machine used in a feedback mechanism.

FIG. 4 is a diagram illustration of an embodiment showing a simple finite state machine.

### DETAILED DESCRIPTION

The notion of a relational database may be generalized and used to implement state machines. The generalized relational database concepts may allow for enhanced expressive power from relational database applications, as well as for using state machines to implement relational databases.

The standard relational database may be represented by sets of rows, which we may define as ‘collections’ and tuples or rows, which we may define as ‘generics’.

Throughout this document the notation M<T> is used to discuss collections, where M represents a collection and T represents the data type of items stored in the collection. In order for collections to operate, several axioms exist:
Ø::M<T>—An empty collection
U::M><T>×M<T>→M<T>—Union of two collections produces another collection.
{_}::T→M<T>—Inject a value into a collection. In this case, a single element, or singleton, collection may be created.

Several common operators are used in relational algebra for performing operations on databases:
σ::M<T>×(T→bool)→M<T>—Filter or selection operation from relational algebra. The function (T→bool) is the filter function.
π::M<T>×(T→S)→M<S>—Projection or transformation operation changes collection from type T to type S.
X::M<T>×M<S>M<T×S>—A pair of collections may be made into a collection of pairs.

One more operator is defined:
SelectMany::M<T>×(T→M<S>)→M<S>—Correlated subqueries from relational algebra. A function (T→M<S>) defines how elements of M<T> are broken into a collection of S type elements, then flattened into a collection of S elements.

The SelectMany operator may be used to express any of the above relational algebra operations defined above.

σ(as)=as.SelectMany (λa→P(a)?{a}:0)—Filters items ‘a’ from collection ‘as’ using function P(a). Each item λa is processed by P(a), and either a singleton collection {a} is created or an empty collection is created. The items are then flattened or joined into a new collection with the same type as the original set.
π(as)=as.SelectMany (λa {F(a)})—Project items by applying a function F(a) and creates a singleton set. The singleton sets are flattened or joined into a new collection with the same type as the original set.
as X bs=as.SelectMany (λa→σ_{λb}→_{(a,b)}(bs))—A pair of collections ‘as’ and ‘bs’ are joined.

The function used in SelectMany may be any representation of code. In some cases, the function may be an object or description in some cases, as well as executable functions.

Using the SelectMany notation above, various monads emerge:
A collection, M<_> corresponds to a functor
The operator SelectMany corresponds to bind
A singleton collection {_} corresponds to return or η

A join monad takes a collection of collections and flattens the result into a single collection:

μ::M<M<T>>→M<T>

The join monad can be represented using SelectMany.

μtss=tss.SelectMany(λts→ts)

Thus, the database descriptors and operators may be generalized as monads. The technologies of database query engines may be applied to the more generalized notion of monads.

A Mealy machine is a finite state machine, which may be generalized to the notion of monads.

A Mealy machine is a 6-tuble (S, S₀, Σ, Λ, T, G) consisting of the following:
a finite set of states (S)
a start state or initial state (S₀), which is an element of S
a finite set called the input alphabet (Σ)
a finite set called the output alphabet (Λ)
a transition function (T:S×Σ→S) mapping a state and the input alphabet to the next state
an output function (G:S×Σ→Λ) mapping each state and the input alphabet to the output alphabet

The functions of the Mealy machine may be expressed as the following, where a* indicates a collection of the items:

Next::State×Input→State

Out::State×Input→Output

Run::State×Input*×((State×Input→State)×(State×Input→Output))→(Output×State)*

The expression of Run indicates that the collection of Input and State results in a collection of Output and State.

These expressions may be further generalized, where the State×Input→State and State×Input→Output functions may be combined to create a single function that produces a pair of outputs:

State×Input→Output×State

The outputs may be a collection of outputs.

State×Input→Output*×State

The Mealy machine Run expression may be rewritten as:

State×Input*×(State×Input→Output*×State)→(Output×State)*

In a programming language, global state is implicit, reducing the above expression to:

Input*×(Input→Output*)→Output*

A collection of a sequence of inputs, a function that converts inputs to a sequence of outputs results in a sequence of outputs.

This expression may be defined using SelectMany in the .NET framework as:
IEnumerable<T> SelectMany (this IEnumerable<S> src, Func<S, IEnumerable<T>> selector)

When the selector function is side-effecting, the expression can be used to implement a state machine. The Mealy machine described above is illustrated as a finite state machine, but the expression may also be used to implement an infinite state machine. A side-effecting function may be any function that changes a state outside of the input and output parameters, i.e., in the environment.

The side effecting functions may be used in conventional database language systems for expressing state machines. The inputs to the state machines may be considered ‘events’ that the state machine may process. In processing the events, the state may be updated and output generated.

A database query language processor may be used to express a state machine by defining a query input as a sequence of states. The sequence of states may be bound to the sequence input using a transforming function to create an output event stream. When the transforming function has side effects, those side effects may define the state of the state machine as it responds to the input event stream.

The type of inputs may be different from the type of outputs in certain conditions. The following statement holds true if and only if N<T>→M<T>:

M<I>×(I→N<O>)→M<O>

Similarly, the following statement holds true if and only if M<N<O>>→N<O>:

M<I>×(I→N<O>)N<O>

In some embodiments, an input may be created as a push or pull inputs. A pull input may request an input and may wait until an input is received before processing the input. In a push input, the state machine may receive an input at any time and process the input upon its arrival.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be for example, but not limited to, an electronic, magnetic, optical, electromagnetic, infrared, or semiconductor system, apparatus, device, or propagation medium. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and may be accessed by an instruction execution system. Note that the computer-usable or computer-readable medium can be paper or other suitable medium upon which the program is printed, as the program can be electronically captured via, for instance, optical scanning of the paper or other suitable medium, then compiled, interpreted, of otherwise processed in a suitable manner, if necessary, and then stored in a computer memory.

Communication media typically embodies computer-readable instructions, data structures, program modules or other data in a modulated data signal such as a carrier wave or other transport mechanism and includes any information delivery media. The term “modulated data signal” can be defined as a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above-mentioned should also be included within the scope of computer-readable media.

When the subject matter is embodied in the general context of computer-executable instructions, the embodiment may comprise program modules, executed by one or more systems, computers, or other devices. Generally, program modules include routines, programs, objects, components, data structures, and the like, that perform particular tasks or implement particular abstract data types. Typically, the functionality of the program modules may be combined or distributed as desired in various embodiments.

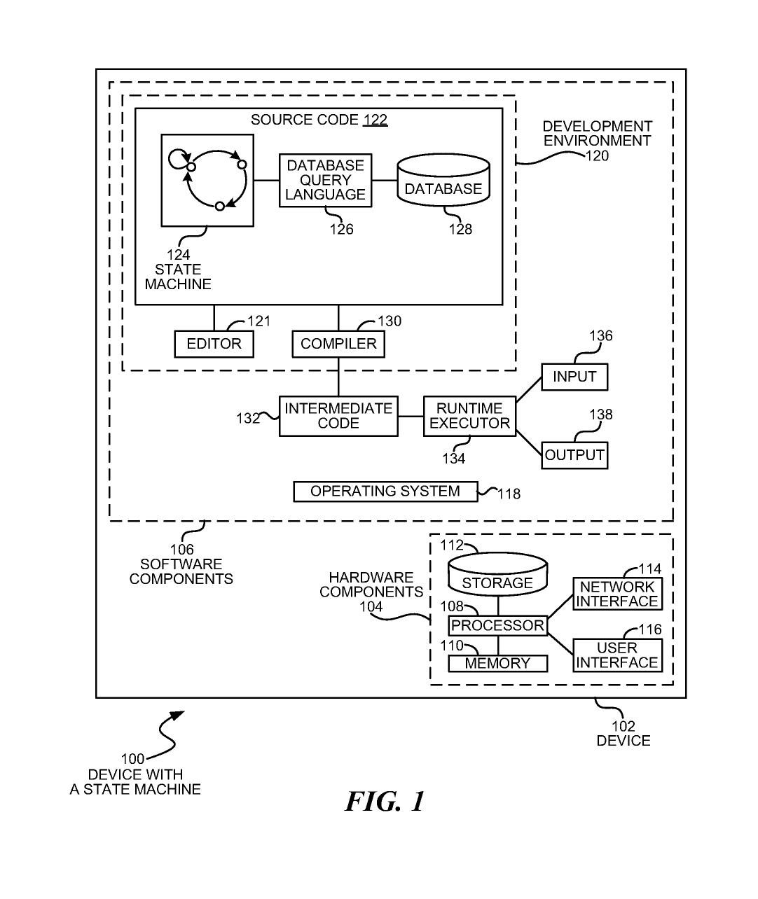

FIG. 1 is a diagram of an embodiment 100, showing a device that may be used for developing and executing computer programs that implement state machines. Embodiment 100 is a simplified example of a generic computer on which a state machine may be created and debugged. The resulting executable may be executed on the same device or another device.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the described functions.

The device 102 may be a conventional computer device that may be used for developing, editing, testing, and executing computer programs. The device 102 illustrates a development platform on which executable computer programs may be created and executed. Other devices may execute the computer programs developed on the device 102 without being able to edit or change the computer program.

The device 102 may have a set of hardware components 104 and software components 106. The various components represent a generic computing device, which may be a server computer, desktop computer, game console, or other computer device. In some cases, the computing device may be a portable device, such as a laptop computer, netbook computer, hand held mobile phone, or other device.

The computer program created by the device 102 may be executed on any type of hardware or software platform, including the devices described above, as well as network devices such as routers, switches, storage devices, and other network infrastructure, data collection devices such as hand held diagnostic equipment or remote sensing equipment, portable devices such as mobile phones and handheld gaming devices, or any other type of computing device. The types of devices listed are not meant to be exhaustive, but only to illustrate the breadth of device types that may execute programs developed using the device 102.

The hardware components 104 may include a processor 108 that may use random access memory 110 and nonvolatile storage 112. The hardware components 104 may also include a network interface 114 and a user interface 116.

The software components 106 may include an operating system 118 on which a development environment 120 may execute. The development environment 120 may have an editor 121 and compiler 130, and may be used by a programmer to create source code 122. In some embodiments, the compiler 130 may compile the source code 122 into intermediate code 132, which may be executed using a runtime executor 134 to process inputs 136 and generate outputs 138. In other embodiments, the source code 122 may be interpreted without compiling using an interpreter.

Throughout this specification, examples of computer code are illustrated using C# and portions of the .NET framework. Other languages may have different syntax and different commands that may perform similar functions.

The source code 122 may represent a state machine 124 using a database query language 126. In some cases, the database query language 126 may interact with a database 128. Examples of such state machines are illustrated later in this specification.

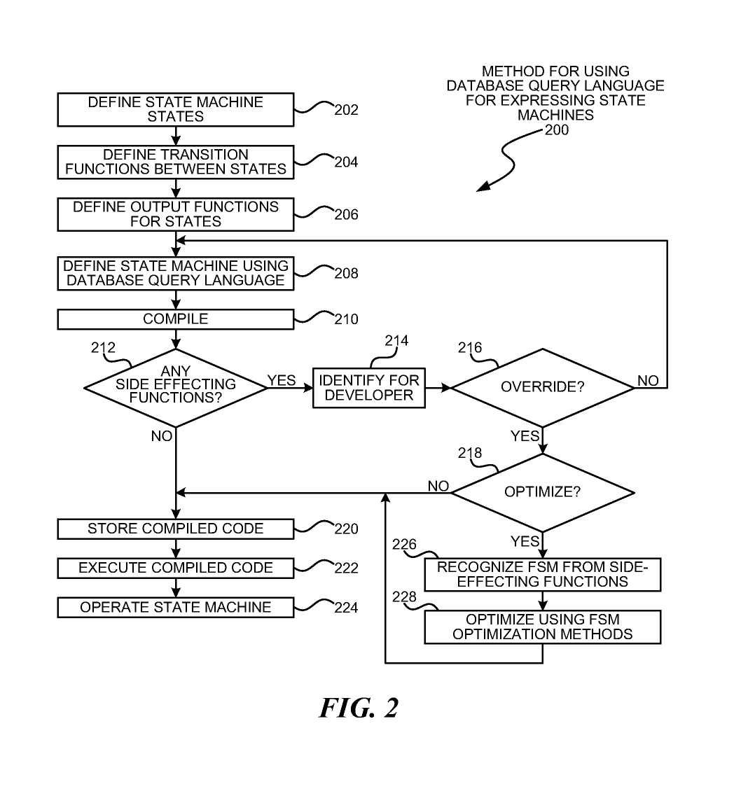

FIG. 2 is a flowchart illustration of an embodiment 200 showing a method for using a database query language to express state machines. Embodiment 200 is a simplified example of the process for creating, compiling, and optimizing programs using a database query language and state machine techniques.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

In block 202, the state machine states may be defined, and the transition functions for the state machine may be defined in block 204. The output functions may be defined in block 206.

The operations of blocks 202 through 206 illustrate the steps a programmer may take in defining a state machine. Two examples of simple state machines are illustrated later in this specification, although state machine technology is widely practiced.

The state machine may be defined using a database query language in block 208. As shown above in this specification, many database query language operators may be generalized into monads, which are also shown to be a generalized form of state machines. Specifically, the bind operator used in many database query languages, can be used to express all of the monad operators conventionally used for functional programming and for expressing state machines. In the language of C# and the .NET framework, the equivalent bind operator is SelectMany.

The state machine may be compiled in block 210. During compilation, if a side effecting function is detected in block 212, a compiler may identify the side effecting function in block 214.

In many programming environments, a side effecting function in a database query language may be an unconventional mechanism for performing database queries. Some database systems may perform certain query optimizations that are predicated on the assumption that the transformation functions are not side effecting. Such optimizations may include reordering the sequence of inputs to optimize searching, for example. Such optimizations may not be performed with side effecting functions that define a state machine, as the state machine uses an ordered set of inputs to create and ordered set of outputs.

The side effecting functions may be identified in block 214 so that the programmer may recognize or approve the use of side effecting functions. If the programmer did not intend to use a side effecting function in block 216, the process may return to block 208 where the programmer may edit the source code.

If the programmer elects to override the identification message in block 216 and no optimization is performed in block 218, the compiled code may be stored in block 220, executed in block 224, and the state machine may be operated in block 226.

In some embodiments where no side effecting functions are found in block 212, the program may be stored in block 220 and executed in block 222. In such an embodiment, the executed program may not operate a state machine.

Some embodiments may perform various optimizations routines when selected in block 218. In block 226, the finite state machine may be identified by the compiler and various finite state machine optimizations may be applied to the code in block 228.

Several different finite state machine optimizations may be applied to the code to optimize the performance of the finite state machine. Such optimizations include the Hoperoft minimization algorithm, using an implication table, and the Moore reduction procedure. Other optimization mechanisms may also be applied to the state machine and may minimize memory consumption, improve response time, reduce code size, and other performance enhancements.

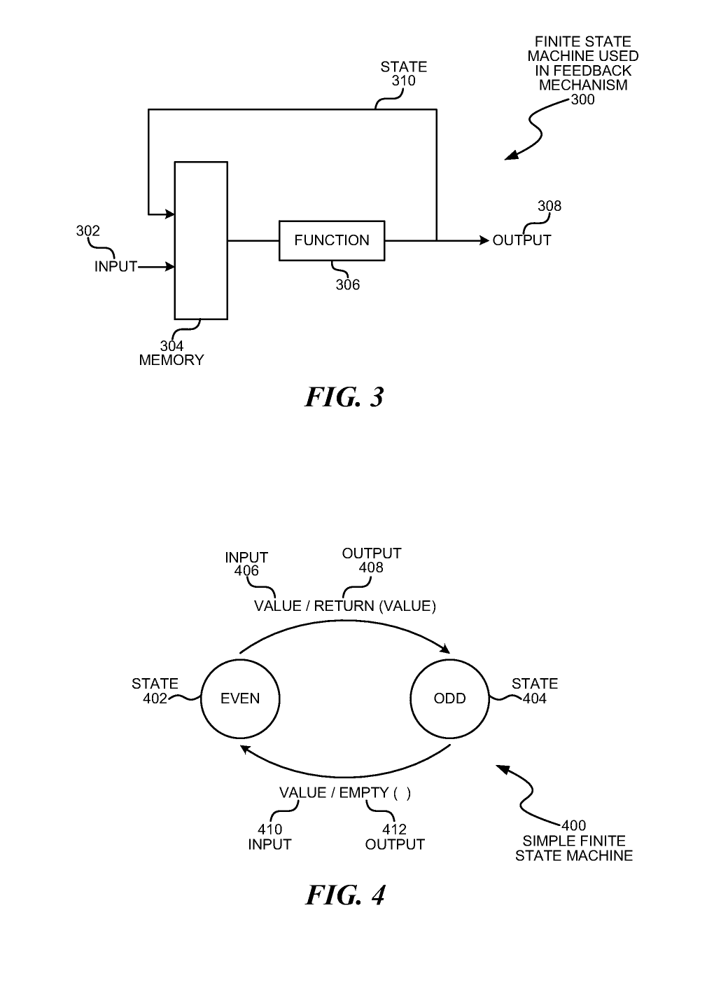

FIG. 3 is a diagram illustration of an example embodiment 300, showing a state machine that may be implemented using the database query language.

The state machine of embodiment 300 illustrates a simple feedback loop. An input 302 enters a memory 304, which may store a current state. A transformation function 306 may produce an output 308 and a new state 310. The new state 310 is fed back into the memory 304.

The feedback loop of the state machine of embodiment 300 may be defined where the input 302 is defined as a collection, and the result of the function 306 may be defines as a collection of pairs of (output and state). The functions defined above may express embodiment 300 as:

State×Input*×(State×Input→Output*×State)→(Output×State)*

The input 302 may be defined as a push collection of inputs. A push collection of input may wait until a new input is received before launching the function 306. The memory 304 may synchronize the change of the state 310 with the change in input 302.

FIG. 4 is a diagram illustration of an example embodiment 400, showing a simple state machine. Embodiment 400 is a simple example of a two-state state machine that may be implemented simply using a database query language.

The state machine of embodiment 400 is a state machine that may analyze a database table and remove the odd rows of the table. The state machine has two states. The first state 404 is ‘Even’ and the second state 406 is ‘Odd’. A transfer function from state 402 to state 404 has an input 406 of ‘value’ and an output 408 of ‘return(value)’. A transfer function from state 404 to state 402 has an input 410 of ‘value’ and an output 412 of ‘empty( )’.

The state machine of embodiment 400 may be represented in C# as:

class OnlyEvenElements<T>

$$\{ \begin{matrix}bool Even = true ; \\ IEnumerable 〈 T 〉 Next ( T value ) \\ \{ if ( Even ) \{ Even = false ; return Return ( value ) ; \} \\ else \{ Even = true ; return Empty 〈 T 〉 0 ; \}\end{matrix} \}$$

The class OnlyEvenElements above uses a collection of inputs as defined by IEnumerable<T> and produces an output of the even elements of the items in IEnumerable<T>. The state of the state machine is a Boolean expression: either Even or odd, where odd is defined as Even=false.

The object ‘IEnumerable<T>’ may present a single value from a collection T, and the operator ‘Next’ may increment the collection to the next object in the collection. The collection has a data type of T.

Then the state machine is executed, the even numbered elements of data type T are kept and the odd numbered elements are discarded.

The state machine represented by OnlyEvenElements<T> would be very difficult to program using other methods, but yields a single and elegant solution when the database query language is used to express a state machine.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A system comprising:
a processor;
a database query language processor that
receives an input definition comprising an event stream comprising a plurality of events and a binding operator comprising a transforming function and creating an output event stream;
said system configured to perform a method comprising:
representing a state machine by defining said transforming function with side effects, said side effects defining at least one state in said state machine;
operating said state machine by providing said input definition and executing said transforming function on said input definition using said database query language processor.

2. The system of claim 1, said database query language processor that further:
recognizes said side effects in said function.

3. The system of claim 2, said database query language processor that further:
provides a notification for said side effects.

4. The system of claim 1, said state machine having:
a set of states;
a transition function defining a condition for changing from a first state to a second state;
an output function that produces an output given a state and an input;
said function comprising said transition function.

5. The system of claim 4, said input definition being a push input.

6. The system of claim 4, said input definition being a pull input.

7. The system of claim 4, said set of states comprising a start state and an end state.

8. The system of claim 7 further comprising an intermediate state.

9. The system of claim 1, said database query language processor comprising:
a set of standard query operators comprising operators for map, filter, bind, and fold operations;
said database query language processor that performs said operators on a sequence data type comprising a collection of items having a data type.

10. The system of claim 9, said database query language processor that further:
recognizes said state machine from said function; and
performs a finite state machine optimization when executing said state machine.

11. The system of claim 10, said optimization being one of a group composed of:
Hoperoft minimization algorithm;
implication table; and
Moore reduction procedure.

12. A method comprising:
representing a state machine by defining a function with side effects, said side effects defining at least one state in said state machine;
expressing said function in a database query language;
defining an input for said state machine comprising a sequence of events;
executing said state machine using said database query language using said input.

13. The method of claim 12 further comprising:
compiling said function into compiled code; and
detecting said side effects in said function during said compiling.

14. The method of claim 13 further comprising:
presenting a warning in a user interface referencing said side effects.

15. The method of claim 13 further comprising:
performing a finite state machine optimization on said compiled code.

16. The method of claim 12, said state machine representing a feedback loop with memory.

17. A system comprising:
a processor;
a source code comprising:
an input object comprising a series of events;
a function that processes said series of events, said function being defined in said database query language and having side effects, said function further representing a state machine having states represented by at least one of said side effects;
a compiler that
receives said source code, said source code comprising a database query language;
compiles said source code; and
creates an executable code
a runtime executor that
executes said executable code to operate said state machine using said input.

18. The system of claim 17, said compiler that further:
detects said side effects in said function;
represents said function as said state machine;
performs a finite state machine optimization on said state machine to create optimized code; and
creates said executable code from said optimized code.

19. The system of claim 17, said state machine being a finite state machine.

20. The system of claim 17, said source code further comprising an output function, said output function being dependent on said states.
